(19) United States
(12) Patent Application Publication
(10) Pub. No.: US 2007/0073615 A1
(43) Pub. Date: Mar. 29, 2007

(54) Presentation instrument transaction processing pricing systems and methods

(75) Inventor: Giancarlo Marchesi, Huntington, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/241,765

(22) Filed: Sep. 29, 2005

(51) Int. Cl. G06Q 40/00

(52) U.S. Cl. 705/39

(57) ABSTRACT

A method of processing a presentation instrument transaction for a merchant. includes, at a host computer system, receiving transaction information from the merchant for a presentation instrument transaction to process. The transaction information includes a ticket amount. The method also includes, at the host computer system, determining a settlement amount to pay the merchant for the transaction. The settlement amount is less than the ticket amount and the difference between the ticket amount and the settlement amount is based, at least in part, on a fee. The method further includes remitting a payment to the merchant. The payment includes the settlement amount. The method also includes further processing the transaction to thereby obtain reimbursement. The fee is determined, at least in part, by calculating an expected loss specific to the merchant. The expected loss is based, at least in part, on a probability of default specific to the merchant and a gross exposure specific to the merchant. The presentation instrument transaction may be based on a presentation instrument such as a credit card, gift card, stored value card, or debit card.

### CROSS-REFERENCES TO RELATED APPLICATIONS

This application is related to the following co-pending, commonly assigned United States Patent Applications: application Ser. No. 10/108,781, entitled “DECISION TREE SYSTEMS AND METHODS” (Attorney Docket No. 020375-008200US), by Mark G. Arthus, et al.; application Ser. No. 10/109,198, entitled “MERCHANT APPLICATION AND UNDERWRITING SYSTEMS AND METHODS” (Attorney Docket No. 020375-007100US), by Michael L. Sgaraglio, et al.; application Ser. No. 10/108,934, entitled “MERCHANT ACTIVATION TRACKING SYSTEMS AND METHODS” (Attorney Docket No. 020375-023900US), by Michael L. Sgaraglio, et al.; and application Ser. No. 10/108,575, entitled “SYSTEMS AND METHODS FOR MONITORING CREDIT RISK” (Attorney Docket No. 020375-008500US), by Michael L. Sgaraglio, the entirety of each of which are herein incorporated by reference for all purposes.

### BACKGROUND OF THE INVENTION

Embodiments of the invention relate generally to the field of financial transaction processing. More specifically, embodiments of the invention relate to systems and methods for pricing presentation instrument transaction processing.

Financial transactions involving the use of presentation instruments, such as credit cards, play an important role in today's economy. A typical credit card transaction proceeds by extracting account information from the credit card, typically using a point of sale device at a merchant location, and submitting the account information along with a requested payment amount to a processing system. Such a processing system may involve the merchant's bank, a credit card association and associated processing network, such as the VISA® network or the MASTERCARD® network, and/or the issuer's bank, as is known in the art.

Hence, in order to process a credit card transaction, a merchant typically establishes an account with a processing organization. Because the processing organization takes on certain financial risks when agreeing to process a merchant's transactions, an application and underwriting process typically takes place before an account is opened. For example, an account may be established by first requiring the merchant to fill out a credit application. The credit application is then sent to an underwriter who reviews information in the application to determine whether the merchant would be a suitable client. If so, the account is established, and the merchant may begin accepting at least certain types of credit cards as payment for their goods or services.

In return for processing a merchant's transactions, the processing organization charges the merchant a fee, usually a percentage of each transaction. There is a need, however, for improved systems and methods for setting the fee.

### BRIEF SUMMARY OF THE INVENTION

Embodiments of the invention provide a method of processing a presentation instrument transaction for a merchant. The method includes, at a host computer system, receiving transaction information from the merchant for a presentation instrument transaction to process. The transaction information includes a ticket amount. The method also includes, at the host computer system, determining a settlement amount to pay the merchant for the transaction. The settlement amount is less than the ticket amount and the difference between the ticket amount and the settlement amount is based, at least in part, on a fee. The method further includes remitting a payment to the merchant. The payment includes the settlement amount. The method also includes further processing the transaction to thereby obtain reimbursement. The fee is determined, at least in part, by calculating an expected loss specific to the merchant. The expected loss is based, at least in part, on a probability of default specific to the merchant and a gross exposure specific to the merchant. The presentation instrument transaction may be based on a presentation instrument such as a credit card, gift card, stored value card, or debit card.

In some embodiments, the method includes calculating the probability of default specific to the merchant as a function of a merchant risk score specific to the merchant. The merchant risk score includes a weighted summation of one or more attributes that may include: 12 month Chargeback percent; Ratio of 30 day Credit percent to 180 day Credit percent; # of 60+ Trade lines in 24 months; 30 day Keyed sales $; Number of Recurring Sales over 12 Months; Ratio of total balance to high credit/credit limit for all bank revolving accounts; Ratio of 30 day Chargeback percent to 180 day Chargeback percent; 12 month Credit percent (12 month Credit $/12 month Sales $); Ratio of number of declined Authorizations over 12 months to number of sales over 12 months; and Number of trade lines. The probability of default may be derived from the merchant risk score using a lookup table. The gross exposure specific to the merchant may be determined, at least in part, as a function of undelivered goods or services for which the merchant has been paid. The fee may be further determined, at least in part, by calculating a contribution specific to the merchant, wherein the contribution comprises a difference between revenue generated from the merchant and expenses attributable to the merchant. The fee may be further determined, at least in part, by determining a risk adjusted contribution specific to the merchant. The risk adjusted contribution is based, at least in part, on the contribution and the expected loss.

In still other embodiments, a method of determining a fee to charge a merchant for processing presentation instrument transactions for the merchant includes, over a period of time, processing presentation instrument transactions for the merchant. Each transaction may include transaction information. The method also includes, at a host computer system, collecting the transaction information, at the host computer system, using the transaction information, at least in part, to calculate an expected loss specific to the merchant. The expected loss may be based, at least in part, on a probability of default specific to the merchant and a gross exposure specific to the merchant. The method also includes using the expected loss to determine a fee to charge the merchant for processing the merchant's future presentation instrument transactions and, thereafter, charging the merchant the fee to process a new presentation instrument transaction.

In some embodiments, the new presentation instrument transaction is based on a presentation instrument which may be a credit card, gift card, stored value card, or debit card. The probability of default may be derived from the merchant risk score using a lookup table. The gross exposure specific to the merchant may be determined, at least in part, as a function of undelivered goods or services for which the merchant has been paid. The method may include calculating a contribution specific to the merchant. The contribution may be a difference between revenue generated from the merchant and expenses attributable to the merchant. The method also may include calculating a risk adjusted contribution based, at least in part, on the contribution and the expected loss and using risk adjusted contribution, at least in part, to determine the fee.

In still other embodiments, a presentation instrument transaction processing system includes a host computer system and computer-executable instructions that program the host computer system to receive transaction information from a merchant for a presentation instrument transaction to process. The transaction information may include a ticket amount. The computer-executable instructions also program the host computer system to determining a settlement amount to pay the merchant for the transaction. The settlement amount is less than the ticket amount and the difference between the ticket amount and the settlement amount is based, at least in part, on a fee. The computer-executable instructions also program the host computer system to initiate a process to remit a payment to the merchant. The payment includes the settlement amount. The computer-executable instructions also program the host computer system to further process the transaction to thereby obtain reimbursement.

In some embodiments, the computer-executable instructions further program the host computer system to determine the fee, at least in part, by programming the host computer system to calculate an expected loss specific to the merchant. The expected loss is based, at least in part, on a probability of default specific to the merchant and a gross exposure specific to the merchant. The presentation instrument transaction may be based on a presentation instrument such as a credit card, gift card, stored value card, or debit card. The computer-executable instructions further program the host computer system to calculate the gross exposure specific to the merchant, at least in part, as a function of undelivered goods or services for which the merchant has been paid. The computer-executable instructions may further program the host computer system to determine the fee, at least in part, by calculating a contribution specific to the merchant, wherein the contribution comprises a difference between revenue generated from the merchant and expenses attributable to the merchant. The computer-executable instructions may further program the host computer system to determine the fee, at least in part, by calculating a risk adjusted contribution specific to the merchant, wherein the risk adjusted contribution is based, at least in part, on the contribution and the expected loss.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary system according to embodiments of the invention.

FIG. 2 illustrates an exemplary method according to embodiments of the invention, which method may be embodied in the system of FIG. 1.

FIG. 3 illustrates an exemplary method for determining a merchant's Risk-Adjusted Contribution, according to embodiments of the invention.

### DETAILED DESCRIPTION OF THE INVENTION

Embodiments of the present invention provide systems and methods for setting or resetting the fees (i.e., pricing and re-pricing) presentation instrument processing organizations charge merchants for the service. The fee is set such that it accounts for the processing organization's expected loss if the merchant were to go out of business or otherwise default on its credit or business obligations. This detailed description presents the invention in a non-limiting example relating to credit card processing organizations. Other embodiments include processing other types of presentation instruments, including, for example, debit cards, gift cards, stored value cards, and the like. Throughout this description, reference is made to certain well-known systems, products and processes, such as, for example, the Internet, web sites, web site browsers, databases, and the like, which will not be described in detail in order not to unnecessarily obscure the present invention. In light of this detailed description, those skilled in the art will realize how to make and use the present invention in a number of different embodiments using a range of equivalents to elements discussed herein, all of which are within the scope of the present invention as defined by the claims that follow.

Credit card transaction processing services are known, one example of which is the service provided by FIRST DATA® of Englewood, Colo. When a business entity (hereinafter “merchant”) desires to accept credit cards or other presentation instruments as payment for goods or services, it typically engages the services of a credit card processor (hereinafter “processor” or “processing organization”) to process its transactions. Systems and methods for establishing and maintaining merchant accounts are more fully explained in previously-incorporated U.S. patent application Ser. No. 10/109,198, entitled “MERCHANT APPLICATION AND UNDERWRITING SYSTEMS AND METHODS” and in previously-incorporated U.S. patent application Ser. No. 10/108,934, entitled “MERCHANT ACTIVATION TRACKING SYSTEMS AND METHODS”. Because credit processing organizations assume a certain degree of credit risk by accepting a merchant as a client, the application process includes an underwriting process wherein the credit processing organization estimates the degree of credit risk exposure.

Credit risk exposure may result from a number of factors. For example, the method by which a merchant obtains a customer's account number may introduce a degree of exposure. In-person sales using a point of sale device generally introduce less risk than other transaction methods. This is so for a variety of reasons, including, for example: the merchant is able to verify certain information about the customer presenting the credit card as payment; the transaction is posted immediately; and the customer acknowledges the transaction by signing a receipt. On the other hand, mail order and telephone order transactions, wherein account information is given over the phone or through the mail, eliminate many of the safeguards inherent to in-person transactions. This is also the case with Internet sales. Thus, the credit card processing organization may become exposed to greater risk, especially between the time that the merchant is paid and the time that payment is received from the customer.

Another factor that may affect credit risk exposure is the number of days between the transaction and the delivery of the product or service. For example, a merchant who accepts credit card payments for meals at a restaurant does not generate the degree of credit risk as does a merchant providing travel services booked months in advance. The risk varies as well in relationship to the frequency with which a merchant delivers a product or service according to a particular delivery schedule considered to be an industry average.

One method for categorizing merchants according to credit risk is by industry. Using the well-known SIC code system, or Standardized Industrial Classification code system, credit processing organizations may compare merchants with other merchants according to their SIC code. Because merchants within a particular SIC code tend to have similar percentages of mail order and telephone order sales and similar delivery times and patterns, the credit risk associated with merchants in a particular SIC code tends to be similar. Thus, credit processing organizations use industry-specific criteria in the credit underwriting process.

Once a merchant is accepted as a client and the merchant begins accepting credit cards and other presentation instruments for payment, the processing organization places a point-of-sale device at the merchant's business location(s) or otherwise provides the merchant the ability to transfer transaction details to the processor. The details minimally include the customer's account identifier and the amount of the transaction (a.k.a., “ticket amount”). The processor credits a portion of the transaction amount (a.k.a., “settlement amount”) to the merchant's bank account and initiates the process of obtaining funds from the customer. The processor typically withholds a portion of the transaction amount as compensation for processing the transaction. The amount withheld may be a percentage of the transaction amount, a flat fee, a percentage of a total volume processed for the merchant, or the like. According to embodiments of the invention, the amount includes the expected loss allocable to the merchant.

“Expected loss” is a statistical term derived from the more commonly-known term “expectation.” Mathematically, expectation is a summation of the probability of each possible outcome of an event multiplied by the consequences of each outcome. For example, wagering $1 on the flip of a true coin (i.e., statically perfect in that heads should occur with the same frequency as tails in the long run) has a zero expectation per event, since 50% of the time you will win $1 and 50% of the time you will lose $1. If, however, you were to find someone to pay you $2 for each time the coin comes up heads in exchange for $1 each time the coin comes up tails, then your expectation is $0.50 per event (($2×50%)+(−$1×50%)). “Expected loss” then is the negative return portion of the equation.

With respect to processing merchant transactions, expected loss may account for any event that would cause the processor to lose money in the merchant relationship. For example, the merchant may go out of business, in which case, the processor could lose money for any undelivered goods or services for which customers paid with a presentation instrument. The processor may have already paid the merchant for the transaction but will be unable to collect from the merchant's customers or will have to refund the customers' money who never received the benefit of the transaction. Similarly, the merchant may change processors, in which case the processor may not receive unamortized setup costs for the merchant or otherwise lose money as a result of the attrition. Many such examples are possible.

As a processor's universe of merchants expands (i.e., the “long run” kicks in), it becomes increasingly possible to fairly allocate expected loss to individual merchants. The expected loss then may be incorporated into the fee the processor charges the merchant for the processing service. In other words, according to embodiments of the invention, a specific merchant's transaction processing fee may be a true reflection of the expected loss allocable to the merchant. The expected loss calculation may be based on the merchant's recent history with the processor, in the case of continuing merchants, the merchant's history with another processor, in the case of newly enrolled merchants, or other factors such as the merchant's credit history, business classification, sales volume, delivery schedule, and/or the like. This represents a significant improvement over pricing methodologies that simply categorize merchants into risk groups and price them accordingly.

In a specific embodiment of the present invention, a Merchant Risk Score (MRS) is calculated based on measurable data specific to the merchant. If the data are not available (e.g., the merchant is newly acquired, has changed businesses, etc), the MRS may be based on expected ranges of the data, the merchant's history with another processor, a credit report on the business owner, a credit report on the business entity, and the like. If the data are estimated, the merchant may be re-scored—and possibly re-priced—after a statistically-significant quantity of data has been collected.

The data may be any of a variety of attributes, which may be weighted in the calculation of the score. Attributes include, for example, 12 month chargeback percentage, a ratio of total balance to high credit/credit limit for all bank revolving accounts, the number of trades 60 days or more delinquent in 24 months, 12 month declines authorization number/12 month sales number, and/or the like, as will be explained in more detail hereinafter.

Once the MRS is calculated, a Probability of Default (P_{d}) may be calculated as a function of the MRS. The specific function that converts MRS to P_{d} may change over time, based on experience. The function may be linear, or may include other variables or terms that relate the two. In some embodiments, the P_{d} is extracted from a lookup table that relates the two.

The P_{d} is then used to calculate an Expected Loss (EL) by applying the P_{d} to the Gross Exposure (GE) relating to the merchant. The GE is a measure of the loss the processor would experience if the merchant defaulted. It may be an average over a period of time (e.g., one year, one month, the merchant's longevity, etc.) and may be sampled at any frequency (e.g., daily, weekly, monthly, etc.). The GE may include, for example, the total volume of undelivered goods and/or services, a fraction of total volume to account for charge backs, a fraction of total volume to account for disputes, and/or the like.

In some embodiments, the EL is then used to adjust the profit derived from the merchant (Revenue-Expenses), to produce a Risk-Adjusted Contribution (RAC) from the merchant. For existing merchant clients, if the RAC produces an unacceptably low (or unreasonably high) profit margin, then the merchant may be re-priced. That is, the fee may be adjusted so that the revenue term results in the desired RAC. For newly acquired merchants, the fee may be adjusted based on expected revenue to produce the desired RAC, and the merchant may be monitored going forward and re-priced accordingly.

In practical application, a software routine may be set up to periodically (e.g., daily) extract the necessary variables from a database of transaction information associated with a mainframe that processes transactions. The previously-described calculations may be performed on the data to calculate the merchant's RAC. Allowed fluctuations may be predetermined so that only deviations outside the range will be flagged to an exceptions file for further evaluation by an underwriter, clerk, or the like.

In some embodiments, the MRS is calculated on a different periodic (e.g., monthly) schedule than the RAC (e.g., yearly). Each can be compared to allowed deviations so that exception management is applied to deal only with excessive deviations. In some embodiments, the entire process is automated, including measures such as sending a letter 30 days in advance of a planned fee adjustment, with actual implementation thereafter.

In a specific embodiment, the attributes and the algorithm for using them is as follows:
1. 12 month Chargeback percent (v122)
2. Ratio of 30 day Credit percent to 180 day Credit percent (cd12)
3. # of 60+ Trade lines in 24 months (g066)
4. 30 day Keyed sales $ (v184)
5. Number of Recurring Sales over 12 Months (v59)
6. Ratio of total balance to high credit/credit limit for all bank revolving accounts (br34)
7. Ratio of 30 day Chargeback percent to 180 day Chargeback percent (cb7)
8. 12 month Credit percent (12 month Credit $/12 month Sales $) (v25)
9. Ratio of number of declined Authorizations over 12 months to number of sales over 12 months (v101)

10. Number of trade lines (at01)

If V122 < .00075 then weight_V122 = −1.9545.
Else if V122 < .00755 then weight_V122 = −1.5590.
Else if weight_V122 = 0
If cd12 < .467261 then weight_cd12 = −0.9481.
Else if cd12 < 1.23561 then weight_cd12 = −.2303.
Else weight_cd12 = 0.
Weight_g066 = g066 * 0.4588.
If v184 < 222700 then weight_v184 = −1.0752.
Else weight_v184 = 0.
If v59 < 5 then weight_v59 = −.3177.
Else weight_v59 = 0.
If br34 < 44.1 then weight_br34 = −1.2450.
Else if br34 < 69.05 then weight_br34 = −.2606.
Else weight_br34 = 0.
If cb7 < .460606 then weight_cb7 = −.4891.
Else weight_cb7 = 0.
If v25 < .0125 then weight_v25 = −.9061.
Else if v25 < .0345 then weight_v25 = −.5690.
Else weight_v25 = 0.
If v101 < .065 then weight_v101 = −.7583.
Else weight_v101 = 0.
If at01 < 20.5 then weight_at01 = −1.0202.
Else if at01 < 45.5 then weight_at01 = −.6617
Else weight_at01 = 0.
Temp = 2.6499 + weight_at01 + weight_v101 + weight_v25 +
weight_cb7 + weight_br34 + weight_v59 + weight_v184 +
weight_g066 + weight_cd12 + weight_v122.
P = 1/(1+ exp(−Temp)).
Score = 1000 * (1−P).

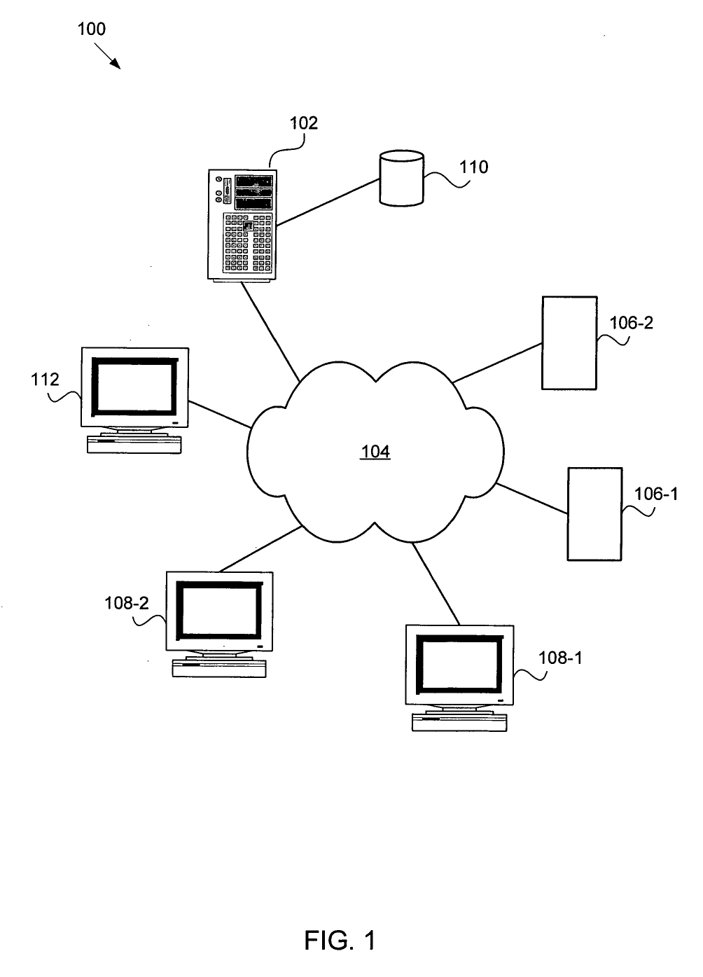

Having described embodiments of the present invention generally, attention is directed to FIG. 1, which illustrates an exemplary system 100 according to embodiments of the invention. Those skilled in the art will appreciate that the system 100 is merely exemplary of a number of possible systems according to embodiments of the invention. The system 100 includes a server computer 102 (a.k.a., “host computer system”) connected to a network 104. The server computer 102 may be any of a number of computing devices known to those skilled in the art, such as, for example, a personal computer, a workstation, or the like. Application programs residing on the server computer 102 allow the server computer to send and receive files from other computing devices. A suitable interface, as is known in the art, allows the server computer 102 to communicate with other devices via the network 104. The network 104 may be, for example, a wide area network, a local area network, the Internet, or the like.

The server computer 102 is configured to receive merchant credit transaction information from one or more point of sale deices 106 or credit processing computers 108. Exemplary point-of-sale devices are described in U.S. Pat. No. 6,547,132. The server computer 102 causes the transaction information to be stored on a data storage arrangement. The data storage arrangement, or database 110, may be any one or a combination of well-known types of recording media, including, for example, magnetic tape, disk drives, optical storage systems and the like. The database 110 may be integral to the server computer 102 or located elsewhere such that the server computer 102 accesses the database 110 via a network.

Through the network 104, the server computer 102 is able to exchange information with one or more credit risk assessment computers 112. For example, the risk assessment computer 112 periodically requests necessary data from the server computer 102 to calculate MRS, EL, and/or RAC for one or more merchants. If the calculations fall outside of pre-determined ranges or deviate more than a predetermined amount from prior calculations for specific merchants, then the exceptions may be flagged for further processing, either manually or automatically.

The server computer 102 and/or the credit risk assessment computer 112 may be configured more specifically to perform the methods of the present invention. It merits noting that in some embodiments of the present invention, the server computer 102, the credit risk assessment computer 112 and the database 110 exist together in a single computing device.

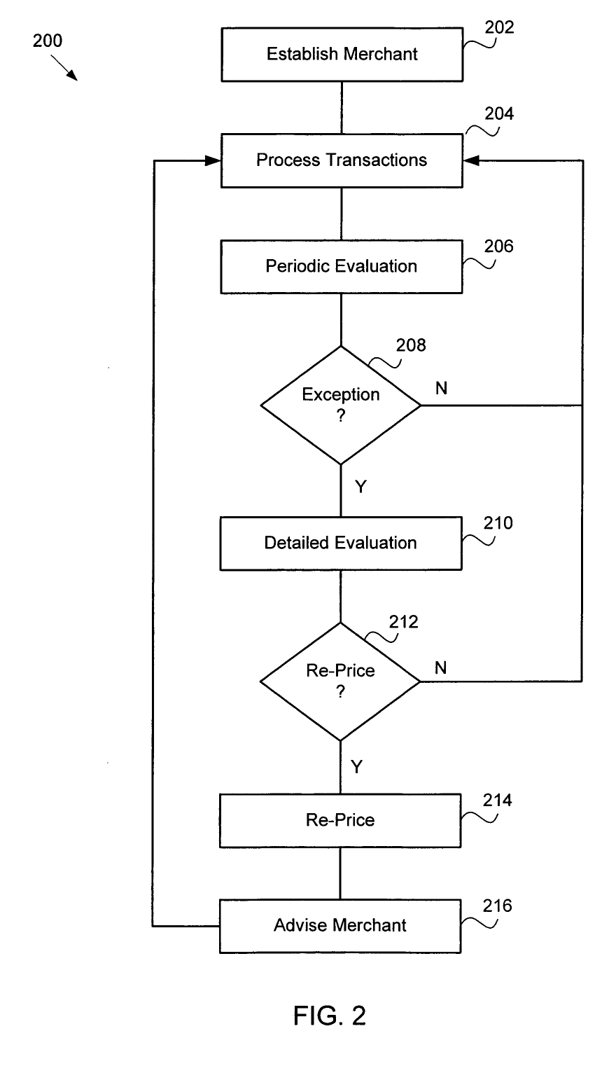

Having described an exemplary system 100 according to embodiments of the invention, attention is directed to FIG. 2, which illustrates a method 200 of pricing or re-pricing presentation instrument transaction processing. The method may be embodied in the system of FIG. 1, or other appropriate system. Those skilled in the art will appreciate that the method 200 is merely exemplary and that other methods according to other embodiments may have more, fewer, or different steps than those illustrated and described herein. Further, other methods according to other embodiments may traverse the steps illustrated and described herein in different orders.

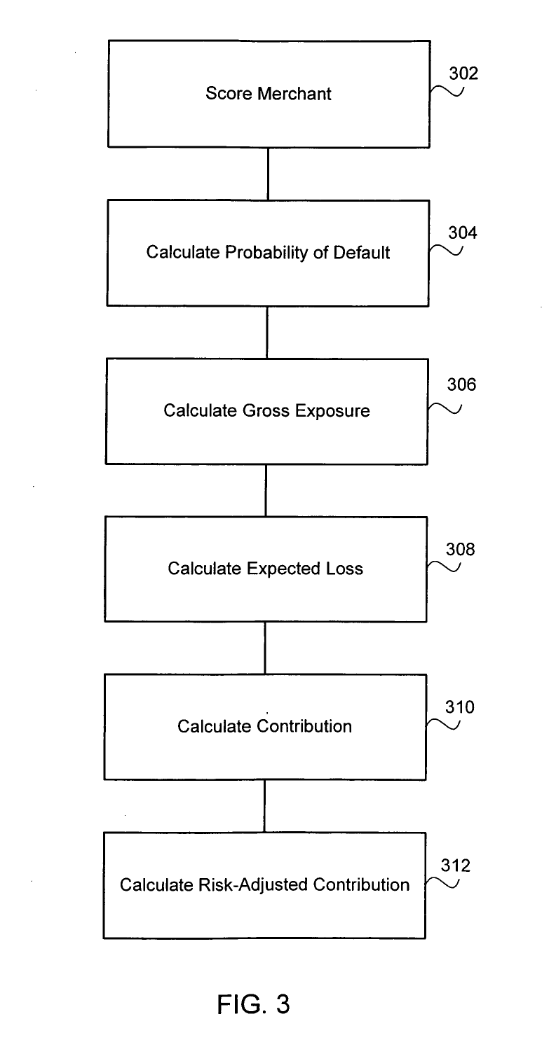

The method begins at block 202 at which point a merchant is set up as a presentation instrument transaction processing client. Doing so may include taking an application, underwriting the application, establishing a fee, installing any necessary hardware, and/or the like. The underwriting process may be accomplished according to the teachings of previously-incorporated U.S. patent application Ser. No. 10/109,198, entitled “MERCHANT APPLICATION AND UNDERWRITING SYSTEMS AND METHODS” and/or previously-incorporated U.S. patent application Ser. No. 10/108,934, entitled “MERCHANT ACTIVATION TRACKING SYSTEMS AND METHODS”. Establishing the fee may be accomplished according to the teachings herein, to be described more fully with reference to FIG. 3, in which certain unknown variables are estimated.

Once the merchant is established as a client, the merchant's transactions are processed at block 204. Transaction processing includes receiving transaction information from the merchant, reimbursing the merchant for the transaction amount, less a fee, storing the transaction data for later evaluation, and collecting from the merchant's customer.

At block 206, the merchant is periodically evaluated. This may include calculating a Merchant Risk Score (MRS) for the merchant, calculating the merchant's Expected Loss (EL), calculating the Merchant's Risk-Adjusted Contribution (RAC), reviewing key variables in any of the foregoing factors, and/or the like. The evaluation may be accomplished daily, weekly, monthly, annually, or on any useful frequency. In some embodiments, the process includes extracting the necessary information from the database 110 of FIG. 1 and performing the appropriate calculations at the risk assessment computer 112 of FIG. 1.

Once the evaluation is accomplished at block 206, the result(s) are evaluated at block 208 to determine if the merchant should be flagged as an exception. The merchant may be flagged based on a factor being out of a specific range, above or below predetermined thresholds, outside a predetermined deviation from a prior calculation, and/or the like. Further, the threshold(s), ranges, and acceptable deviations may be unique to each factor (i.e., a different threshold for MRS than RAC) and/or each evaluation frequency. If the merchant is not flagged, the process loops back to block 204.

If the merchant is flagged, the merchant may be evaluated in detail at block 210. The detailed evaluation may include calculating additional factors, reviewing the merchant's history for the presence on anomalous events, contacting the merchant, and/or the like. Conveniently, the process may be facilitated through the use of a decision tree. Decision trees are more fully explained in previously-incorporated U.S. patent application Ser. No. 10/108,781, entitled “DECISION TREE SYSTEMS AND METHODS”. This may allow the processing organization to substantially reduce the cost of labor for performing such evaluations by employing less skilled administrative personnel to accomplish tasks typically reserved to analysts or underwriters.

Once the detailed evaluation is complete, a decision is made at block 212 whether to re-price the merchant. If the merchant is to be re-priced, this is accomplished at block 214, by adjusting the merchant's fee to a level that would produce an acceptable RAC. The merchant is advised of the re-pricing at block 216, and the new fee generally takes effect some period of time later. The merchant may be advised, for example, by email, personalized letter, computer-generated letter, and/or the like. The advisement may include a new contract or may simply be a modification to a preexisting contract, in which case the advisement may be according to the terms of the preexisting contract. Thereafter, the process loops back to block 204. If the merchant is not to be re-priced, the process loops back to block 204 from block 212 without re-pricing the merchant.

Having described the overall process 200 of processing merchant transactions and pricing the merchant accordingly, attention is directed to FIG. 3, which illustrates a method 300 of accomplishing the computational portion of the method 200 in greater detail. As with the method 200 of FIG. 2, the method 300 is merely exemplary, and other methods according to other embodiments may have more, fewer, or different steps than those illustrated and described herein. Further, other methods according to other embodiments may traverse the steps illustrated and described herein in different orders. The method 300 may be embodied in the system 100 of FIG. 1 or other appropriate system. Further, the individual steps of the method 300 may be distributed among two or more of the steps illustrated and described with respect to FIG. 2, rather than being all performed within one of the steps, which may be the case.

The method 300 begins by calculating the Merchant's Risk Score (MRS) at block 302. The MRS is calculated by weighting any of a number of factors and combining them to produce the score. The factors may be subjected to a range, such that there is a minimum and maximum possible contribution from each factor. In a specific embodiment, the factors combine to produce a number in the range 0 to 999.

Once the MRS is calculated, the MRS is converted to a Probability of Default (P_{d}) at block 304. The P_{d} may have a linear relationship to the MRS, may be an output from a lookup table using the MRS as an input, or the like. The formula, function, table, or the like used to determine P_{d} from MRS may change over time based on how accurately history reflects reality, the objective being to predict future losses as accurately as possible.

At block 306, the gross exposure relating to the merchant is determined based on the merchant's actual processing history. The merchant's gross exposure (GE) typically is not a statistical number; it is an accurate reflection of the amount of money the processor would lose if the merchant were to default. While the GE may be an average over a given time based on a particular sampling frequency, it is not typically an estimate based on predictions for the merchant specifically or a larger population. GE may include the average gross volume of undelivered goods or services, an average of charge backs over a specific time, an average of disputes resolved against the merchant over time, and/or the like. Other GE calculations may include other factors, some of which may be statistical approximations.

Having determined the P_{d} and GE for the merchant, the Expected Loss (EL) attributable to the merchant may be determined. This is accomplished in this embodiments by simply multiplying the two factors at block 308.

At block 310, the contribution (i.e., profit) derived from the merchant is calculated by subtracting from the revenue derived from the merchant the expenses associated with processing the merchant's transactions and maintaining the merchant as a client. This term may be based on a specific time frame, which should be the same time frame used for calculating other terms. From this result, a Risk-Adjusted Contribution (RAC) is calculated by subtracting the EL attributable to the merchant from the merchant's contribution.

Those skilled in the art will appreciate that other embodiments may use different terms than those described herein to calculate a merchant's EL and RAC. The present invention, however, includes any merchant transaction pricing strategy that determines an EL for a specific merchant and uses the merchant-specific EL to determine a merchant-specific transaction processing fee, whether that fee is a flat amount per transaction, a flat percentage per transaction, a variable percentage based on a transaction amount, and/or the like.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention, which is defined in the following claims.

What is claimed is:

1. A method of processing a presentation instrument transaction for a merchant, comprising:
at a host computer system, receiving transaction information from the merchant for a presentation instrument transaction to process, wherein the transaction information includes a ticket amount;
at the host computer system, determining a settlement amount to pay the merchant for the transaction, wherein the settlement amount is less than the ticket amount and wherein the difference between the ticket amount and the settlement amount is based, at least in part, on a fee;
remitting a payment to the merchant, wherein the payment includes the settlement amount; and
further processing the transaction to thereby obtain reimbursement;
wherein the fee is determined, at least in part, by:
calculating an expected loss specific to the merchant, wherein the expected loss is based, at least in part, on a probability of default specific to the merchant and a gross exposure specific to the merchant.

2. The method of claim 1, wherein the presentation instrument transaction is based on a presentation instrument selected from a group consisting of credit card, gift card, stored value card, and debit card.

3. The method of claim 1, further comprising calculating the probability of default specific to the merchant as a function of a merchant risk score specific to the merchant, wherein the merchant risk score comprises a weighted summation of one or more attributes selected from a group consisting of:
12 month Chargeback percent;
Ratio of 30 day Credit percent to 180 day Credit percent;
# of 60+ Trade lines in 24 months;
day Keyed sales $;
Number of Recurring Sales over 12 Months;
Ratio of total balance to high credit/credit limit for all bank revolving accounts;
Ratio of 30 day Chargeback percent to 180 day Chargeback percent;
12 month Credit percent (12 month Credit $/12 month Sales $);
Ratio of number of declined Authorizations over 12 months to number of sales over 12 months; and
Number of trade lines.

4. The method of claim 3, wherein the probability of default is derived from the merchant risk score using a lookup table.

5. The method of claim 3, wherein the gross exposure specific to the merchant is determined, at least in part, as a function of undelivered goods or services for which the merchant has been paid.

6. The method of claim 5, wherein the fee is further determined, at least in part, by calculating a contribution specific to the merchant, wherein the contribution comprises a difference between revenue generated from the merchant and expenses attributable to the merchant.

7. The method of claim 6, wherein the fee is further determined, at least in part, by determining a risk adjusted contribution specific to the merchant, wherein the risk adjusted contribution is based, at least in part, on the contribution and the expected loss.

8. A method of determining a fee to charge a merchant for processing presentation instrument transactions for the merchant, the method comprising:
over a period of time, processing presentation instrument transactions for the merchant, wherein each transaction includes transaction information;
at a host computer system, collecting the transaction information;
at the host computer system, using the transaction information, at least in part, to calculate an expected loss specific to the merchant, wherein the expected loss is based, at least in part, on a probability of default specific to the merchant and a gross exposure specific to the merchant;
using the expected loss to determine a fee to charge the merchant for processing the merchant's future presentation instrument transactions; and
thereafter, charging the merchant the fee to process a new presentation instrument transaction.

9. The method of claim 8, wherein the new presentation instrument transaction is based on a presentation instrument selected from a group consisting of credit card, gift card, stored value card, and debit card.

10. The method of claim 8, further comprising calculating the probability of default specific to the merchant as a function of a merchant risk score specific to the merchant, wherein the merchant risk score comprises a weighted summation of one or more attributes selected from a group consisting of:
12 month Chargeback percent;
Ratio of 30 day Credit percent to 180 day Credit percent;
# of 60+ Trade lines in 24 months;
30 day Keyed sales $;
Number of Recurring Sales over 12 Months;
Ratio of total balance to high credit/credit limit for all bank revolving accounts;
12 Ratio of 30 day Chargeback percent to 180 day Chargeback percent;
12 month Credit percent (12 month Credit $/12 month Sales $);
Ratio of number of declined Authorizations over 12 months to number of sales over 12 months; and
Number of trade lines.

11. The method of claim 10, wherein the probability of default is derived from the merchant risk score using a lookup table.

12. The method of claim 10, wherein the gross exposure specific to the merchant is determined, at least in part, as a function of undelivered goods or services for which the merchant has been paid.

13. The method of claim 12, further comprising calculating a contribution specific to the merchant, wherein the contribution comprises a difference between revenue generated from the merchant and expenses attributable to the merchant.

14. The method of claim 13, further comprising:
calculating a risk adjusted contribution based, at least in part, on the contribution and the expected loss; and
using risk adjusted contribution, at least in part, to determine the fee.

15. A presentation instrument transaction processing system, comprising:
a host computer system; and
computer-executable instructions that program the host computer system to:
receive transaction information from a merchant for a presentation instrument transaction to process, wherein the transaction information includes a ticket amount;
determining a settlement amount to pay the merchant for the transaction, wherein the settlement amount is less than the ticket amount and wherein the difference between the ticket amount and the settlement amount is based, at least in part, on a fee;
initiate a process to remit a payment to the merchant, wherein the payment includes the settlement amount; and
further process the transaction to thereby obtain reimbursement;
wherein the computer-executable instructions further program the host computer system to determine the fee, at least in part, by programming the host computer system to:
calculate an expected loss specific to the merchant, wherein the expected loss is based, at least in part, on a probability of default specific to the merchant and a gross exposure specific to the merchant.

16. The system of claim 15, wherein the presentation instrument transaction is based on a presentation instrument selected from a group consisting of credit card, gift card, stored value card, and debit card.

17. The system of claim 15, wherein the computer-executable instructions further program the host computer system to calculate the probability of default specific to the merchant as a function of a merchant risk score specific to the merchant, wherein the merchant risk score comprises a weighted summation of one or more attributes selected from a group consisting of:
12 month Chargeback percent;
Ratio of 30 day Credit percent to 180 day Credit percent;
# of 60+ Trade lines in 24 months;
30 day Keyed sales $;
Number of Recurring Sales over 12 Months;
Ratio of total balance to high credit/credit limit for all bank revolving accounts;
Ratio of 30 day Chargeback percent to 180 day Chargeback percent;
12 month Credit percent (12 month Credit $/12 month Sales $);
Ratio of number of declined Authorizations over 12 months to number of sales over 12 months; and
Number of trade lines.

18. The system of claim 17, wherein the computer-executable instructions further program the host computer system to calculate the gross exposure specific to the merchant, at least in part, as a function of undelivered goods or services for which the merchant has been paid.

19. The system of claim 18, wherein the computer-executable instructions further program the host computer system to determine the fee, at least in part, by calculating a contribution specific to the merchant, wherein the contribution comprises a difference between revenue generated from the merchant and expenses attributable to the merchant.

20. The system of claim 19, wherein the computer-executable instructions further program the host computer system to determine the fee, at least in part, by calculating a risk adjusted contribution specific to the merchant, wherein the risk adjusted contribution is based, at least in part, on the contribution and the expected loss.
